(19) United States
(12) Patent Application Publication
(10) Pub. No.: US 2009/0257011 A1
(43) Pub. Date: Oct. 15, 2009

(54) LIQUID CRYSTAL DISPLAY DEVICE AND ELECTRONIC APPARATUS

(75) Inventor: Teruyuki MIZUMOTO, Shiojiri-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/416,970

(22) Filed: Apr. 2, 2009

(30) Foreign Application Priority Data
Apr. 14, 2008 (JP) 2008-104373
Jan. 19, 2009 (JP) 2009-008510

(51) Int. Cl. G02F 1/1333; G02F 1/13363

(52) U.S. Cl. 349/117; 349/122

(57) ABSTRACT

A liquid crystal display device includes a first substrate and a second substrate that are disposed to face each other, a liquid crystal layer that is pinched by the first substrate and the second substrate, a phase difference layer that is disposed on a side of the second substrate which is located on the liquid crystal layer side, a protection layer that covers a face of the phase difference layer that faces the first substrate and a side face of the phase difference layer that is connected to the face of the phase difference layer so as to be brought into contact with a base face that becomes a base of the phase difference layer, and a spacer that is disposed in a position for being overlapped with the protection layer and maintains the first substrate and the second substrate to be spaced apart by a predetermined gap. The hardness of the protection layer is higher than that of the phase difference layer.

### BACKGROUND

1. Technical Field

The present invention relates to a liquid crystal display device and an electronic apparatus.

2. Related Art

As optical modulation devices of various electro-optical apparatuses, liquid crystal display devices are used. In the liquid crystal display devices, a phase difference frequently occurs in transmitted light due to a difference of light path lengths that are used for transmission of light inside the devices or a difference of birefringence of a plurality of types of materials. Accordingly, there is a problem that a displayed image may be blurred. Thus, generally, optical compensation for the phase difference is performed by using various methods. In order to eliminate a phase difference due to the birefringence, a configuration in which a phase difference layer for eliminating the phase difference is disposed has been known.

As display methods by using the liquid crystal display devices, there are a display method of a reflective-type for emitting modulated light to the incident side and a display method of a transmissive-type for emitting modulated light to the other side other than the incident side of light. Moreover, semi-transmissive and semi-reflective liquid crystal display devices having the above-described two display modes have been known. The semi-transmissive and semi-reflective liquid crystal display devices use several display modes including a reflective mode and a transmissive mode in accordance with the degree of brightness in the surrounding area. Accordingly, the semi-transmissive and semi-reflective liquid crystal display devices have an advantage that clear display can be performed even for a case where the surrounding area is dark with power consumption reduced.

In the semi-transmissive and semi-reflective liquid crystal display devices, in order to implement high-quality image display by performing display of a same quality in both a reflective display area in which reflective display is performed and a transmissive display area in which transmissive display is performed, various optical compensation processes are performed commonly.

For example, a method of eliminating a difference of light paths in the reflective display area and the transmissive display area by disposing a liquid crystal layer-thickness adjusting layer that controls the layer thickness of the liquid crystal layer in the reflective display area to be smaller than the layer thickness in the transmissive display area, that is, by using so-called a multi-gap structure has been known. In JP-A-2005-242297, JP-A-2003-167253, JP-A-2004-361825, and JP-A-2003-344839, configurations in which the layer thickness of the liquid crystal layer is controlled by using a spacer that is disposed on the liquid crystal layer-thickness adjusting layer, in addition to the multi-gap structure have been disclosed. In addition, in JP-A-2005-338256 and JP-A-2004-226829, configurations in which the phase difference is eliminated by disposing a phase difference layer on a color filter layer and performing optical compensation by using the phase difference layer as a multi-gap structure have been disclosed.

However, when a configuration in which optical compensation is performed by using the phase difference layer as the liquid crystal layer-thickness adjusting layer is applied to a configuration in which the spacer is disposed on the liquid crystal layer-thickness adjusting layer, a new problem arises.

Generally, as a formation material of the phase difference layer, a liquid crystal polymer having an anisotropic refractive index is used. However, the hardness of the phase difference layer becomes low due to properties of the liquid crystal polymer. Thus, when stress applied to the liquid crystal display device is transferred to the liquid crystal layer-thickness adjusting layer through the spacer, the hardness of the phase difference layer is low, and accordingly, the liquid crystal layer-thickness adjusting layer collapses on the phase difference layer easily. Therefore, it is difficult to manage the layer thickness to be constant. When the spacer is directly brought into contact with the phase difference layer, the spacer collapses on the phase difference layer. Accordingly, the light path length inside the liquid crystal layer is changed easily, and thus, a displayed image may be disturbed easily.

### SUMMARY

An advantage of some aspects of the invention is that it provides a liquid crystal display device capable of displaying a high-quality image by managing the layer thickness of the liquid crystal layer with the influence of the hardness of the phase difference layer suppressed and an electronic apparatus having the above-described liquid crystal display device.

According to a first aspect of the invention, there is provided a liquid crystal display device including: a first substrate and a second substrate that are disposed to face each other; a liquid crystal layer that is pinched by the first substrate and the second substrate; a phase difference layer that is disposed on a side of the second substrate which is located on the liquid crystal layer side; a protection layer that covers a face of the phase difference layer that faces the first substrate and a side face of the phase difference layer that is connected to the face of the phase difference layer so as to be brought into contact with a base face that becomes a base of the phase difference layer; and a spacer that is disposed in a position for being overlapped with the protection layer and maintains the first substrate and the second substrate to be spaced apart by a predetermined gap. The hardness of the protection layer is higher than that of the phase difference layer.

Under such a configuration, a spot at which the spacer is disposed is covered with the protection layer having hardness higher than that of the phase difference layer. Thus, when an external force is applied to the liquid crystal display device, stress is dispersed to the phase difference layer through the protection layer having high hardness. In addition, the protection layer having the hardness higher than that of the phase difference layer is formed so as to be brought into contact with the base face. Accordingly, when the same external force is applied, the protection layer covering the side face serves as a support member like a partition or a column so as to oppose the stress. As a result, the stress applied to the phase difference layer is dispersed to the base face through the protection layer covering the side face of the phase difference layer. Accordingly, deformation of the phase difference layer can be suppressed, and a distance between the first substrate and the second substrate can be controlled well by using the spacer. Therefore, the liquid crystal display device capable of displaying a high-quality image can be implemented.

In the above-described liquid crystal display device, it is preferable that a reflective display area and a transmissive display area are disposed within one pixel area, the phase difference layer is disposed in the reflective display area, and the protection layer covers a side face other than a side face of the phase difference layer that is located on a boundary between the reflective display area and the transmissive display area within one pixel area so as to be brought into contact with the base face.

Under such a configuration, the protection layer covers a side face other than a side of the phase difference layer that is located on the boundary between the reflective display area and the transmissive display area. In other words, the protection layer is brought into contact with the base face along the edge surrounding the periphery of the reflective display area. Accordingly, the protection layer covering the side face is formed large so as to be used as a support member having a large area for opposing the stress, and thereby the deformation of the phase difference layer can be suppressed strongly.

In the above-described liquid crystal display device, it is preferable that a plurality of the pixel areas is arranged in one direction, the reflective display area is disposed on one side and the transmissive display area is disposed on the other side with a center line that passes through a center of the pixel area and extends in parallel with the arrangement direction of the pixel areas interposed between the one side and the other side within the pixel areas, the phase difference layer is formed in a band shape over a plurality of the reflective display areas that are aligned in the arrangement direction of the pixel areas, the protection layer covers a face of the phase difference layer formed in the band shape that faces the first substrate and a side face of the phase difference layer that is connected to the face of the phase difference layer and is located on a side opposite to the center line so as to be brought into contact with the base face, and the spacer is disposed in a boundary portion of an adjacent pixel area.

In order to manage the layer thickness of the liquid crystal layer to be uniform by using a spacer having a fixed height, the thickness of a spot at which the spacer is disposed needs to be approximately uniform. Under such a configuration, the phase difference layer and the protection layer are formed to be continuous, and accordingly, there is no spot having a difference in the layer thickness between pixels. In addition, the spacer can be disposed in an area between the pixels, and accordingly, it is possible to improve the aperture ratio of the pixel without a displayed image blocked by the spacer. Moreover, the phase difference layer and the protection layer can be formed in an easy manner by using a patterning process. As a result, the degree of freedom of design is improved, and the liquid crystal display device that can be manufactured in an easy manner can be achieved.

In the above-described liquid crystal display device, it is preferable that the spacer is disposed on a side opposite to the transmissive display area relative to a center line that passes through the center of the reflective display area and extends in parallel with the arrangement direction of the pixel areas.

Under such a configuration, the protection part that covers the side face of the phase difference layer and the spacer are disposed in close positions in the plan view. Accordingly, the spacer and the protection part integrally oppose the stress, and thereby pressure from the outside of the liquid crystal display device can be supported effectively.

In the above-described liquid crystal display device, it is preferable that a reflective display area and a transmissive display area are disposed within one pixel area, the phase difference layer is disposed in the reflective display area, and the protection layer covers a side face including a side face of the phase difference layer that is located on a boundary between the reflective display area and the transmissive display area within one pixel area so as to be brought into contact with the base face.

Under such a configuration, the protection layer is brought into contact with the base face along the edge surrounding the periphery of the reflective display area including the boundary between the reflective display area and the transmissive display area. Accordingly, the deformation of the phase difference layer can be suppressed further.

In the above-described liquid crystal display device, it is preferable that the phase difference layer has a flat surface on a face that faces the first substrate, and the spacer is disposed to be overlapped with the flat surface.

For example, when the phase difference layer is formed by using a photolithographic method, the side face of the phase difference layer may be in the shape of a taper, so that the thickness thereof is not constant. However, in the phase difference layer having the side face of such a shape, by disposing the spacer on the flat surface, the layer thickness of the liquid crystal layer can be managed assuredly.

In the above-described liquid crystal display device, it is preferable that the protection layer serves as a liquid crystal layer-thickness adjusting layer for adjusting the layer thickness of the liquid crystal layer in the transmissive display area and the reflective display area.

Under such a configuration, by setting the thickness of the protection layer appropriately, the layer thickness of the liquid crystal layer in the transmissive display area and the layer thickness of the liquid crystal layer in the reflective display area can be adjusted without changing the thickness of the phase difference layer. Accordingly, a thickness needed for adjusting the layer thickness of the liquid crystal layer in the transmissive display area and the reflective display area by using the liquid crystal layer-thickness adjusting layer and the phase difference given to the transmitted light by the phase difference layer can be controlled independently.

In the above-described liquid crystal display device, it is preferable that the phase difference layer is formed by using a liquid crystal compound as a material, and the protection layer is formed by using an inorganic material as a material.

Under such a configuration, the protection layer is formed by using an inorganic material as a formation material, and accordingly, the hardness of the protection layer can be set to be much higher than that of the phase difference layer formed by using a liquid crystal compound as a formation material.

In the above-described liquid crystal display device, it is preferable that the hardness of the protection layer is equal to or higher than the hardness of the spacer.

Under such a configuration, collapse or deformation of the protection layer in the spot at which the spacer is disposed is suppressed, and accordingly, the deformation of the phase difference layer can be suppressed further.

In the above-described liquid crystal display device, it is preferable that the spacer is disposed integrally with the protection layer.

Under such a configuration, in the relationship between the phase difference layer and the protection layer, by forming the spacer in a position that is appropriate for managing the layer thickness of the liquid crystal layer in advance, the layer thickness of the liquid crystal layer can be managed well.

In the above-described liquid crystal display device, it is preferable that the spacer is disposed integrally with the first substrate.

Under such a configuration, there is no problem that the protection layer or the phase difference layer is damaged in the spacer forming process, and thereby the liquid crystal display device having high reliability can be implemented.

According to a second aspect of the invention, there is provided an electronic apparatus including the above-described liquid crystal display device.

Under such a configuration, an electronic apparatus that has a display unit capable of displaying a high-quality image can be provided by assuredly managing the layer thickness of the liquid crystal layer.

### BRIEF DESCRIPTION OF THE DRAWINGS

The invention will be described with reference to the accompanying drawings, wherein like numbers reference like elements.

FIG. 1 is a plan view of a liquid crystal display device according to a first embodiment of the invention.

FIG. 2 is a cross-section view showing the configuration of a liquid crystal display device according to the first embodiment.

FIGS. 3A, 3B, and 3C are schematic diagrams showing the configuration of a characteristic part of a liquid crystal display device according to the first embodiment.

FIGS. 4A, 4B, and 4C are explanatory diagrams showing advantages of the first embodiment.

FIGS. 5A and 5B are schematic cross-section views showing formation spots of a spacer according to an embodiment of the invention.

FIG. 6 is a plan view showing disposition of the spacer.

FIG. 7 is a cross-section view showing the configuration of a liquid crystal display device according to a second embodiment of the invention.

FIGS. 8A, 8B, and 8C are schematic diagrams showing the configuration of a characteristic part of a liquid crystal display device according to the second embodiment.

FIGS. 9A and 9B are explanatory diagrams showing advantages of the second embodiment.

FIG. 10 is a cross-section view showing the configuration of a liquid crystal display device according to a third embodiment of the invention.

FIGS. 11A, 11B, and 11C are schematic plan views showing modified examples of an inner side phase difference part.

FIGS. 12A, 12B, and 12C are schematic plan views showing modified examples of an inner side phase difference part.

FIG. 13 is a perspective view showing an example of an electronic apparatus according to an embodiment of the invention.

### DESCRIPTION OF EXEMPLARY EMBODIMENTS

### Liquid Crystal Display Device

### First Embodiment

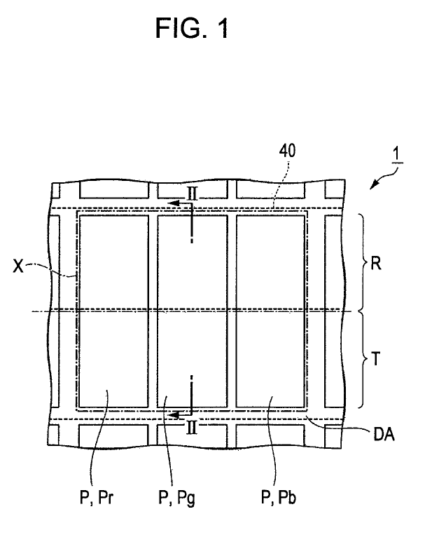

Hereinafter, a liquid crystal display device according to a first embodiment of the invention will be described with reference to FIGS. 1 to 6. In all the drawings described below, for easy understanding of the drawings, the film thickness, the ratio of sizes, and the like of each constituent element are shown to be different appropriately.

FIG. 1 is a plan view of one pixel of the liquid crystal display device 1. The liquid crystal display device 1 includes a plurality of pixels (pixel areas) X. The pixels X are arranged in two directions of arrangement axes, which extend in the horizontal direction and the vertical direction in the figure, so as to be disposed in a matrix shape. As shown in the figure, in one pixel area of the liquid crystal display device 1, three sub pixels P (Pr, Pg, and Pb), which have approximate rectangular shapes in the plan view, corresponding to a red color, a green color, and a blue color are disposed. Here, “r”, “g”, and “b” represent a red color, a green color, and a blue color.

Three sub pixels P that are disposed in each pixel are arranged to be parallel to the arrangement axes that are perpendicular to the long axis directions thereof so as to form one pixel X. Accordingly, the sub pixels P, which have an approximate rectangular shape in the plan view, disposed in each pixel X have their arrangement axes disposed in a same direction. In one sub pixel P, a corresponding color filer layer to be described later is formed so as to be able to display one color of three primary colors including a red color, a green color, and a blue color. Between the pixels, a non-display area DA is formed. In the non-display area DA, for example, a black matrix that is a light shielding member included in the color filter layer is disposed.

The sub pixel P is divided into two areas in the long axis direction. An upper area in the figure is a reflective display area R, and a lower area in the figure is a transmissive display area T. The reflective display area R and the transmissive display area T have an approximately same shape and an approximately same size in the plan view and are adjacent to each other in the center portion of the sub pixel area. In addition, the reflective display areas R of adjacent sub pixels are arranged in an arrangement direction that is parallel to short axis directions of the sub pixels having an approximately rectangular shape in the plan view.

In addition, an inner side phase difference part 40, which has a band shape in the plan view, extends to be overlapped with an adjacent reflective display area R in the plan view as a characteristic part according to an aspect of the invention. One end of end portions of the inner side phase difference part 40 in a direction perpendicular to the extending direction is brought into contact with a boundary between the reflective display area R and the transmissive display area T, and the other end thereof is disposed in an area between pixels.

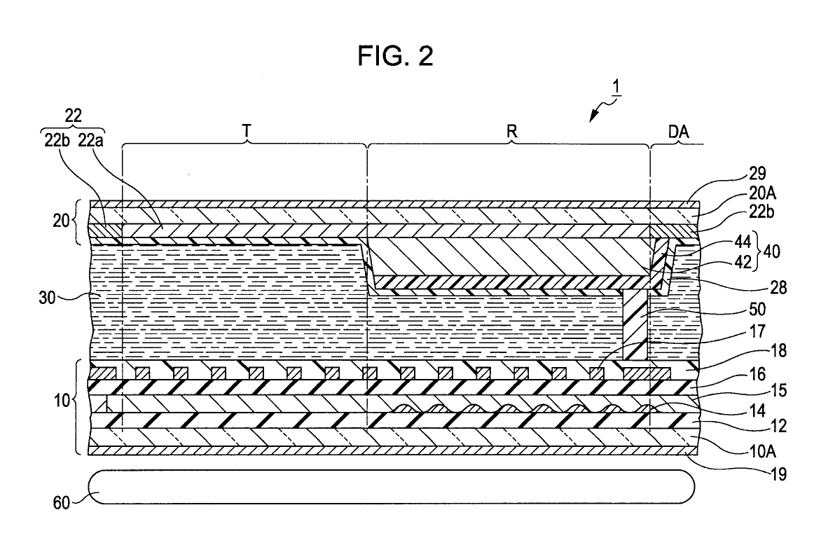

FIG. 2 is a cross-section view of the liquid crystal display device 1 according to this embodiment and is a fragmentary cross-section view taken along line II-II shown in FIG. 1. The liquid crystal display device 1 according to this embodiment employs an FFS mode of a horizontal electric field type in which image display is implemented by applying an electric field component (horizontal electric field) in the direction of a substrate face to a liquid crystal layer 30 so as to control the angle of orientation of a liquid crystal material. The liquid crystal display device 1 is a liquid crystal device having color filters, and one pixel is configured by three sub pixels that emits light of colors including R (red color), G (green color), and B (blue color).

As shown in the figure, the liquid crystal display device 1 includes a component substrate (first substrate) 10 in which a driving element, a wiring, and the like are formed, an opposing substrate (second substrate) 20 that forms a pair with the component substrate 10 and is disposed to face the component substrate 10, a liquid crystal layer 30 that is pinched by the component substrate 10 and the opposing substrate 20, the inner side phase difference part 40 that is formed on a side face of the liquid crystal layer 30 of the opposing substrate 20 so as to be overlapped with the reflective display area R in the plan view, and a spacer 50 that is disposed between the inner side phase difference part 40 and the component substrate 10.

The liquid crystal display device 1 employs a semi-transmissive and semi-reflective display type having a transmissive display area T that performs display by modulating light emitted from a back light 60 in the liquid crystal layer 30 and a reflective display area R that performs display by modulating external light penetrated into the device from the opposing substrate 20 side in the liquid crystal layer 30. According to a technical idea of the invention, the liquid crystal display device is not limited to the FFS mode, and a semi-transmissive and semi-reflective liquid crystal display device using another display mode can acquire the advantages as long as a multi-gap structure is included. In descriptions below relating to FIG. 2, in order to indicate the vertical dispositional relationship of each constituent member, a side on which the back light 60 is disposed is represented as the lower side, and a side on which the opposing substrate 20 is disposed is represented as the upper side.

A substrate main body 10A that is included in the component substrate 10 is formed of a material having optical transparency such as an inorganic material, for example, including glass or silicon nitride, an organic polymer (resin) including acrylic resin or polycarbonate resin, or composite materials thereof.

On the substrate main body 10A, a component layer 12 including a driving element, a wiring, and an insulation film, which is formed of an inorganic material or an organic material, electrically insulating the above-described elements is formed. In addition, various wirings and driving elements can be appropriately formed by performing a patterning process and then performing an etching process by using a photolithography method, and the insulation film can be appropriately formed by using a generally known method such as a vapor-deposition method or a sputtering method.

On the component layer 12, a reflective layer 14 is formed to be overlapped with the reflective display area R in the plan view. The reflective layer 14 is formed by forming a metal reflective film formed of silver, aluminum, or the like on a resin layer formed of acrylic resin or the like. The surface of the resin layer has a concavo-convex shape. Thus, the metal reflective film is formed so as to reflect the concavo-convex shape. Accordingly, the reflective layer 14 configures a light scattering reflective part having a totally concavo-convex surface. Alternatively, the reflective layer 14 may be acquired by selectively forming a film by using a light-reflective metal film formed of silver, aluminum, or the like and a dielectric laminated film (dielectric mirror) that is acquired from laminating dielectric films (SiO₂, TiO₂, and the like) having different refractive indices by using a vapor-deposition method or a sputtering method, for example, through a mask and by forming a concave-convex shape on the surface of the formed film.

In addition, on the component layer 12, a common electrode 15 that covers the reflective layer 14 and the component layer 12 so as to be overlapped with the transmissive display area T and the reflective display area R is formed. The common electrode 15 is formed of a transparent conductive material such as ITO (Indium Tin Oxide).

On the common electrode 15, an interlayer insulation film 16 that is formed of an inorganic insulation film such as silicon oxide for the entire face thereof and covers the surface is formed. On the interlayer insulation film 16, a pixel electrode 17 that is overlapped with the transmissive display area T and the reflective display area R is formed. The pixel electrode 17 is formed of a transparent conductive material such as ITO and forms a ladder shape (opening slits) or a comb teeth shape in the plan view. In addition, on the interlayer insulation film 16, an alignment film 18 that covers the surface of the pixel electrode 17 and is formed of polyimide or the like is formed.

In addition, as a substrate main body 20A that is included in the opposing substrate 20, same as in the substrate main body 10A of the component substrate 10, a substrate having transparency may be used. For example, an inorganic material such as glass, silica glass, or silicon nitride or an organic polymer (resin) such as acrylic resin or polycarbonate resin may be used as the material of the substrate main body 20A. In addition, a composite material that is formed by laminating or mixing the above-described materials may be used as long as the composite material has optical transparency. According to this embodiment, as a material of the substrate main body 20A, glass is used.

On a face of the substrate main body 20A that is located on the inner side of the device, a color filer layer 22 including a coloring layer 22a and a black matrix 22b is formed. Full color display can be performed by modulating light that is incident from the back light 60 and is emitted to the front side of the device and light that is incident from the front side of the device and is reflected by the reflective layer 14 so as to be emitted to the front side of the device in a red color, a green color, and a blue color and mixing light of the colors. In addition, on a face of the color filer layer 22 that is located on the inner side of the device, an overcoat layer not shown in the figure is formed for protecting the color filter layer 22 physically or chemically. The color filter layer 22 may be formed on the component substrate 10 side.

On a face of the color filter layer 22 that is located on the inner side of the device, the inner side phase difference part 40 which is the characteristic part according to an aspect of the invention is disposed so as to be overlapped with the reflective display area R. The inner side phase difference part 40 has a function as a liquid crystal layer-thickness adjusting layer that is used for having the layer thickness of the liquid crystal layer 30 in the reflective display area R thinner than the layer thickness of the liquid crystal layer 30 in the transmissive display area T. The layer thickness of the liquid crystal layer 30 in the reflective display area R is a thickness for providing transmitted light a phase difference of a λ/4 wavelength.

The inner side phase difference part 40 is formed so as to include a phase difference layer 42 and a protection layer 44. The phase difference layer 42 is disposed so as to be overlapped with the reflective display area R. Thus, an end portion of the phase difference layer 42 that is located on a side opposite to the transmissive display area T is formed to extend up to the non-display area DA. The phase difference layer 42 is formed by a generally known method by using a liquid crystal polymer as a formation material that is acquired from polymerizing an ultraviolet-curable liquid crystal material (liquid crystal monomer or liquid crystal oligomer). The phase difference layer 42 is disposed on the inner side of the opposing substrate 20 and is so-called an inner side phase difference layer. The phase difference layer 42 has a function for compensating for a phase difference between an image of the transmissive display area T and an image of the reflective display area R. The phase difference layer 42, for example, provides transmitted light a phase difference of a λ/2 wavelength.

In addition, the protection layer 44 is formed so as to cover the surface of the phase difference layer 42. The protection layer 44 is formed so as to cover the end portion of the phase difference layer 42 that is disposed in the non-display area DA and to be brought into contact with the surface of the color filter layer 22 that is a base face of the phase difference layer 42. The protection layer 44 is formed by a generally known method by using a formation material having a hardness higher than that of the phase difference layer 42, for example, acrylic resin or epoxy resin having photosensitivity as a formation material. As the photosensitivity, both a positive type and a negative type may be used appropriately.

In addition, the spacer 50 that controls the thickness of the liquid crystal layer 30 to be constant is formed so as to be brought into contact with the protection layer 44 that is formed in the non-display area DA. The spacer 50 may be formed of a same material as the formation material of the protection layer 44. Thus, the shape of the spacer 50 is not particularly limited. Thus the shape of the spacer 50 may be a columnar shape such as a cylindrical shape or a polygonal column shape or may be a wall shape having a large width.

The spacer 50 is disposed in a position for being overlapped with the protection layer 44, that is, the reflective display area R. However, in a case where the spacer 50 is disposed in the transmissive display area T, when the thickness of the inner side phase difference part 40 varies, the layer thickness of the liquid crystal layer 30 in the reflective display area R is influenced. According to this embodiment, since the spacer 50 is disposed in the reflective display area R, the layer thickness of the liquid crystal layer 30 in the reflective display area R can be controlled to be a predetermined thickness regardless of the variation of the thickness of the inner side phase difference part 40.

Moreover, on a face of the color filter layer 22 that is located on the inner side of the device, the alignment film 28 is formed on the entire face so as to cover the surface of the inner side phase difference part 40. An alignment film 28 is an organic alignment film that is formed by using a polyimide film. The alignment film 28 is formed by forming a polyimide film on the color filter layer 22 and the phase difference layer 42 and then, rubbing the polyimide film so as to perform an alignment process.

In addition, the component substrate 10 includes a polarizing plate 19 located on a side opposite to the liquid crystal layer 30, and the opposing substrate 20 includes a polarizing plate 29 located on a side opposite to the liquid crystal layer 30. The liquid crystal display device 1 according to this embodiment is configured as described above.

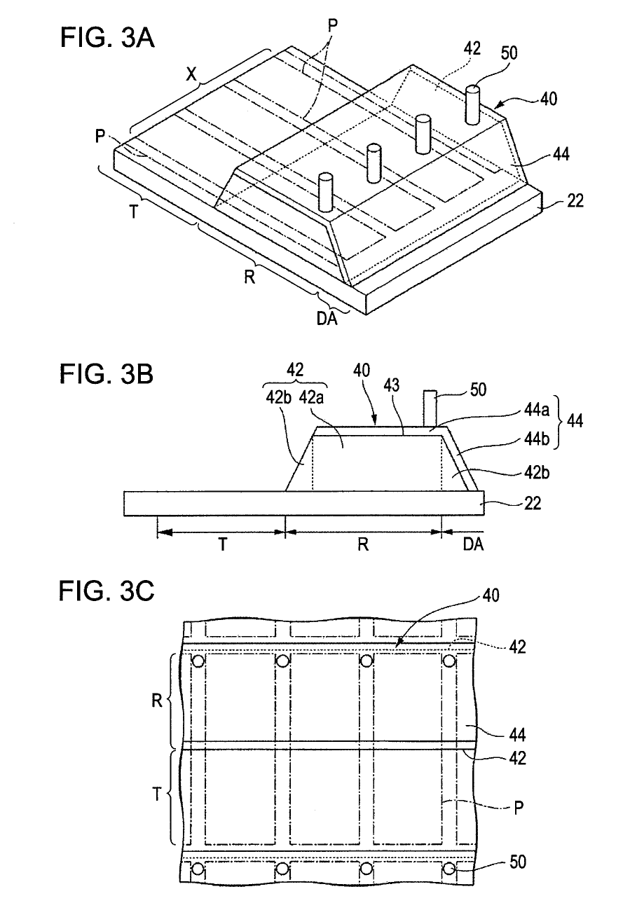

FIGS. 3A, 3B, and 3C are schematic diagrams showing the periphery of the inner side phase difference part 40 according to an aspect of the invention and the spacer 50. FIG. 3A is a perspective view, FIG. 3B is a cross-section view, and FIG. 3C is a plan view. In FIGS. 3A to 3C, for easy understanding of the diagrams, the diagrams are shown to be vertically reversed, compared to FIG. 2.

As shown in FIG. 3A, the inner side phase difference part 40 extends in a band shape over an adjacent pixel X so as to be overlapped with the reflective display area R that is included in the sub pixel P. One end of the inner side phase difference part 40 in a direction perpendicular to the extending direction is brought into contact with the boundary between the transmissive display area T and the reflective display area R. In addition, the other end of the inner side phase difference part 40 is overlapped with the non-display area DA, which is an area between pixels, in the plan view.

The phase difference layer 42 that is included in the inner side phase difference part 40 extends in a band shape over an adjacent pixel X to be overlapped with the reflective display area R in the extending direction of the inner side phase difference part 40. One end of the phase difference layer 42 in a direction perpendicular to the extending direction is brought into contact with the boundary between the transmissive display area T and the reflective display area R. In addition, the other end of the phase difference layer 42 is overlapped with the color filter layer 22 of the non-display area DA, which is an area between pixels, in the plan view.

Similarly, the protection layer 44 extends in a band shape over an adjacent pixel X to be overlapped with the reflective display area R in the extending direction of the inner side phase difference part 40. The protection layer 44 is formed to cover the top portion of the phase difference layer 42 and a side portion of the phase difference layer 42 that is brought into contact with the non-display area DA. The protection layer 44 is formed to be brought into contact with the color filter layer 22 along the end portion of the phase difference layer 42 that is brought into contact with the color filter layer 22 of the non-display area DA. Since the protection layer 44 is brought into contact with the color filter layer 22 in the non-display area DA, a contact face between the protection layer 44 and the color filter layer 22 does not block a displayed image. In addition, the protection layer 44 is not brought into contact with the color filter layer 22 on a boundary side between the transmissive display area T and the reflective display area R, and accordingly, light leakage in the part is suppressed to be low. In addition, since both the phase difference layer 42 and the protection layer 44 are formed in the band shapes over the adjacent pixel X, and accordingly, the inner side phase difference part 40 is formed with a uniform thickness without any layer thickness difference also in the area between the pixels.

As show in FIG. 3B, the phase difference layer 42 that is included in the inner phase difference part 40 is not configured to have a uniform thickness in a section view and has a flat surface 43 on a face facing the component substrate 10 shown in FIG. 2. The phase difference layer 42 is configured by a flat portion 42a that is formed to have an approximately uniform thickness and a side portion 42b that is disposed on the periphery (both sides of the flat portion 42a in the section view) of the flat portion 42a and has a variable thickness. The reason is that the end portion of the phase difference layer 42 becomes a taper shape in a developing process, an etching process, and the like in a case where the phase difference layer 42 is formed by a photolithographic method as a generally known formation method. In correspondence with the shape of the phase difference layer 42, the protection layer 44 is configured by a first protection portion 44a that is formed so as to cover the flat portion 42a and a second protection portion 44b that is brought into contact with the color filter layer 22 so as to cover the side wall portion 42b.

The spacer 50 is disposed on the first protection portion 44a that is overlapped with the flat portion 42a. Since the space 50 is disposed in a position for being overlapped with the flat surface 43 of the flat portion 42a that has a uniform thickness, the thickness of the liquid crystal layer can be regulated with high precision.

In FIG. 3C, the dispositional position of the spacer 50 is shown. The spacer 50 is disposed in a position that is included in an area between adjacent sub pixels P for not being overlapped with the sub pixel P. As described above, since the inner side phase difference part 40 is formed in the band shape, there is no thickness difference in the area between the pixels. Accordingly, when the spacer 50 is disposed in the area between the pixels, the layer thickness can be controlled assuredly. In addition, an image is not blocked by the spacer 50, and accordingly, the aperture ratio of the pixel can be improved.

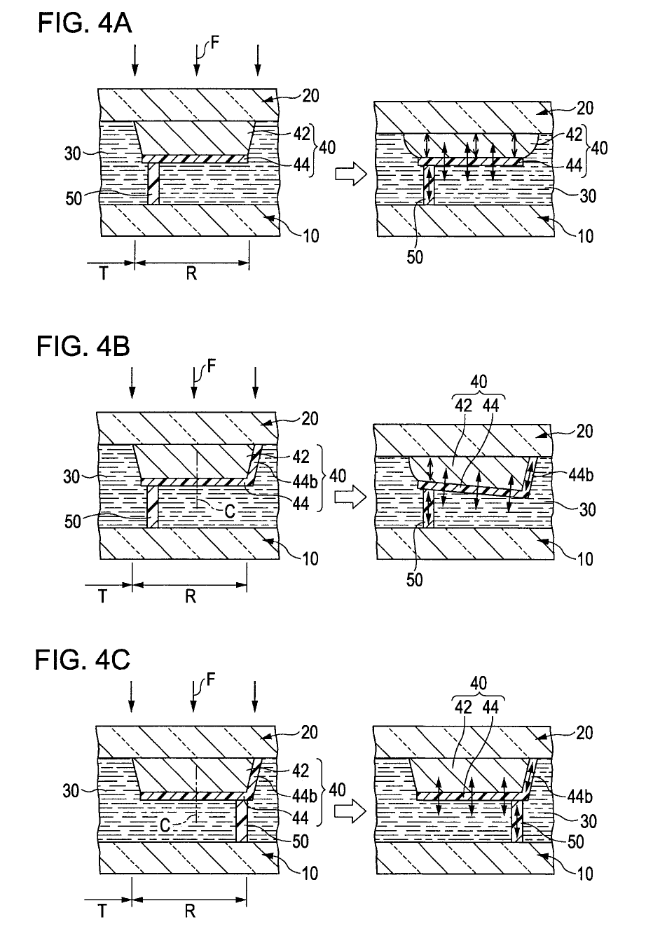

Subsequently, advantages of an embodiment of the invention will be described with reference to drawings. FIGS. 4A, 4B, and 4C are explanatory diagrams showing the advantages of an embodiment of the invention. FIGS. 4A to 4C are schematic cross-section views of the liquid crystal display device showing the periphery of the inner side phase difference part 40 and the spacer 50 and are cross-section views in the direction of a field of view corresponding to FIG. 2.

FIG. 4A shows a case where the protection layer 44 of the inner side phase difference part 40 is not brought into contact with the opposing substrate 20 for a comparative description. FIGS. 4B and 4C show cases where a configuration according to an embodiment of the invention is used. FIG. 4B shows a case where the spacer 50 is disposed on the transmissive display area T side relative to a center line C that passes through the center of the reflective display area R and extends in parallel with the arrangement direction of the pixel area. In addition, FIG. 4C shows a case where the spacer 50 is disposed on a side opposite to the transmissive display area T relative to the center line C.

Here, formation materials of the inner side phase difference part 40 and the spacer 50 will be described. The phase difference layer 42 is formed of a liquid crystal polymer as described above. The liquid crystal polymer that is commonly used for forming the phase difference layer 42 has a hardness of about “6B” of pencil hardness and has very low hardness. On the other hand, the acrylic resin and the epoxy resin that are formation materials of the protection layer 44 and the spacer 50 have high hardness of about “4H” to “6H” of pencil hardness. The “pencil hardness” described here is a value that can be acquired by measuring in accordance with JIS-K5600-5-4 “Clause IV: Scratch Hardness (Pencil Method)—Section V: Mechanical Property of Coating Film—General Test Method—Coating Material”.

As shown in FIG. 4A, a case where an external force F is applied from the outside of the device to the liquid crystal display device having a configuration in which the protection layer 44 is not brought into contact with the opposing substrate 20 will be considered. In such a case, stress is transferred to the inner side phase difference part 40 through the spacer 50, and accordingly, pressure is dispersed over the entire protection layer 44. Accordingly, collapse of the spacer 50 into the phase difference layer 42 can be prevented. However, the stress transferred to the phase difference layer 42 through the protection layer 44 deforms the entire phase difference layer 42, and accordingly, it is difficult to prevent change of the layer thickness of the liquid crystal layer 30.

On the other hand, as shown in FIG. 4B, for a case of the liquid crystal display device having a configuration in which the protection layer 44 is brought into contact with the opposing substrate 20, the stress is transferred to the phase difference layer 42 though the spacer 50 and the protection layer 44 in the same manner. However, since the protection layer 44 is brought into contact with the opposing substrate 20 as the base face, the second protection portion 44b covering the side wall portion of the phase difference layer 42 supports the phase difference layer 42 against the stress so as to disperse the stress to the opposing substrate 20. Accordingly, deformation of the phase difference layer 42 near the second protection portion 44b can be suppressed.

Moreover, as shown in FIG. 4C, a case of the liquid crystal display device in which the protection layer 44 is brought into contact with the opposing substrate 20, and the spacer 50 and the second protection portion 44b are disposed adjacently is more advantageous.

In the disposition as shown in FIG. 4B, when an external force F is applied from the outside of the device, the phase difference layer 42 may be easily deformed by the principle of leverage with the second protection portion 44b used as a fulcrum point, a spot at which the spacer 50 and the protection layer 44 are brought into contact with each other used as a lever point, and an area of the phase difference layer 42 that is overlapped with the spacer 50 in the plan view used as a point of action. Accordingly, although the deformation of the phase difference layer 42 can be suppressed compared to a case of the configuration shown in FIG. 4A, the configuration cannot suppress the deformation of the phase difference layer 42 sufficiently. However, as shown in FIG. 4C, when the second protection portion 44b and the spacer 50 are disposed adjacently, a distance between the fulcrum point and the lever point is short. Accordingly, the leverage cannot work easily, and the stress is dispersed to the opposing substrate 20 more efficiently, whereby the deformation of the phase difference layer 42 can be prevented.

As described above, the protection layer 44 that has hardness higher than that of the phase difference layer 42 protects the phase difference layer 42 that has low hardness, and a part of the protection layer 44 is formed to be brought into contact with the opposing substrate 20, whereby the deformation of the phase difference layer 42 is suppressed efficiently. Accordingly, it is possible to maintain the layer thickness of the liquid crystal layer 30 to be uniform.

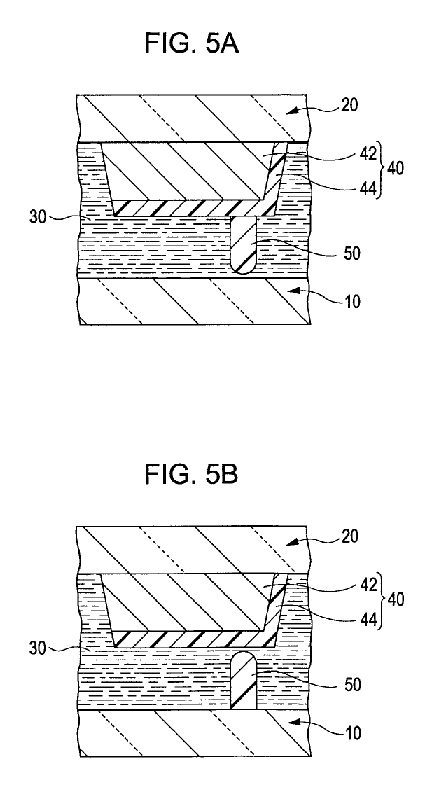

The above-described spacer 50 may be disposed integrally on any side between the component substrate 10 and the opposing substrate 20. FIGS. 5A and 5B are schematic cross-section views showing formation spots of the spacer 50. The spacer 50, as shown in FIG. 5A, may be formed on the protection layer 44 so as to be integral with the protection layer 44. Alternatively, the spacer 50 may be formed on the component substrate 10 side integrally.

According to an embodiment of the invention, as shown in FIGS. 4A to 4C, there is a difference of the advantage depending on a difference of the dispositional position of the spacer 50. As shown in FIG. 5A, when the spacer 50 is disposed on the protection layer 44, the spacer 50 can be formed in a spot for which a high advantage can be acquired, and accordingly, the layer thickness of the liquid crystal layer can be managed well.

On the other hand, as shown in FIG. 5B, when the spacer 50 is formed on the component substrate 10 side, the spacer 50 can be disposed without exposing the phase difference layer 42 and the protection layer 44 to the process of forming the spacer 50. Accordingly, damages of the phase difference layer 42 and the protection layer 44 in the process of forming the spacer 50 are prevented, and thereby a liquid crystal display device having high reliability can be implemented.

According to the liquid crystal display device 1 of the above-described configuration, the spot at which the spacer 50 is disposed is covered with the protection layer 44 that has hardness higher than that of the phase difference layer 42. Thus, when an external force is applied to the liquid crystal display device 1, stress is dispersed to the phase difference layer 42 though the protection layer 44 having high hardness. In addition, the second protection portion 44b is formed to be brought into contact with the color filter layer 22 that is the base face. Accordingly, when the external force is applied in the same manner, the second protection portion 44b that covers the side face of the phase difference layer 42 serves as a support member like a partition or a column so as to oppose the stress. Thus, the stress applied to the phase difference layer 42 is dispersed to the color filter layer 22 though the second protection portion 44b that covers the side face of the phase difference layer 42. As a result, the deformation of the phase difference layer 42 can be suppressed, and a distance between the substrates can be controlled well by the spacer 50, whereby the liquid crystal display device 1 capable of displaying an image with high quality can be implemented.

In addition, according to this embodiment, the liquid crystal display device 1 is a semi-transmissive and semi-reflective liquid crystal display device that has a reflective display area R and a transmissive display area T within one pixel. The phase difference layer 42 is disposed to be overlapped with the reflective display area R in the plan view. In addition, the protection layer 44 is disposed to be brought into contact with the color filter layer 22 so as to cover the side wall portion 42b other than a side face of the phase difference layer 42 that is located on the boundary between the reflective display area R and the transmissive display area T within one pixel. Under such a configuration, the protection layer 44 surrounds the periphery of the reflective display area R so as to be brought into contact with the color filter layer 22. Accordingly, the second protection portion 44b is formed large so as to be used as a support member having a large area for opposing the stress, and thereby the deformation of the phase difference layer 42 can be suppressed strongly.

According to this embodiment, a plurality of pixels X having the reflective display area R and the transmissive display area T is arranged in a matrix shape. Thus, the reflective display areas R that are disposed in each pixel X in the direction of the arrangement axis of the pixels are arranged, and the phase difference layer 42 and the protection layer 44 extend in a band shape over the plurality of pixels X in the direction of the arrangement axis. In addition, the protection layer 44 covers the side face of the phase difference layer 42, which is formed in the band shape, located on a side opposite to the transmissive display area T so as to be brought into contact with the color filter layer 22. In addition, the spacer 50 is disposed in a boundary portion of an adjacent pixel area. The phase difference layer 42 and the protection layer 44 are formed to be continuous, and accordingly, there is no spot having a difference in the layer thickness between pixels. As a result, the spacer 50 can be disposed in an area between the pixels. In such a case, the spacer 50 does not block a displayed image. In addition, the phase difference layer 42 and the protection layer 44 having the above-described shapes can be formed easily by performing a patterning process. Accordingly, the degree of freedom of design is improved, and the liquid crystal display device 1 that can be manufactured in an easy manner can be implemented.

According to this embodiment of the invention, the spacer 50 is disposed on a side opposite to the transmissive display area T relative to the center line that passes through the center of the reflective display area R and extends in parallel with the arrangement direction of the pixel area. When the spacer 50 and the second protection portion 44b are disposed in close positions, the spacer 50 and the second protection portion 44b integrally oppose the stress effectively. Accordingly, the external force F applied from the outside of the liquid crystal display device 1 can be supported effectively.

According to this embodiment, the phase difference layer 42 has a flat surface 43 located on a face facing the component substrate 10, and the spacer 50 is disposed to be overlapped with the flat surface 43. When the phase difference layer 42 is formed by using a formation method such as a patterning method, the side face of the phase difference layer 42 may be in the shape of a taper, so that the thickness thereof is not constant. However, by disposing the spacer 50 on the flat face 43, the layer thickness of the liquid crystal can be managed assuredly.

In addition, according to this embodiment, as the formation material of the protection layer 44, epoxy resin and acrylic resin have been described. However, any other formation material may be used, as long as the formation material has hardness higher than that of the phase difference layer 42. In such a case, the thickness of the second protection portion 44b that covers the side wall portion 42b of the phase difference layer 42 is changed in accordance with the hardness of the used formation material. Accordingly, by having the thickness of the second protection portion 44b to be large for a case where a formation material having low hardness is used, the function of the protection layer 44 as a support member can be acquired.

In addition, according to this embodiment, the protection layer 44 and the spacer 50 are formed of a same formation material, that is, the protection layer 44 and the spacer 50 are configured to have a same hardness. However, as the formation material of the protection layer 44, a formation material having higher hardness than that of the spacer 50 may be used. For example, when epoxy resin or acrylic resin is used as the formation material of the spacer 50, by using an inorganic material such as silicon oxide (SiO₂) or silicon nitride (SiN) as the formation material of the protection layer 44, the hardness of the protection layer 44 can be set to be higher than that of the spacer 50. When the hardness of the protection layer 44 is higher than that of the spacer 50, collapse or deformation of the protection layer 44 in a spot at which the spacer 50 is disposed is suppressed. Accordingly, collapse of the spacer 50 into the phase difference layer 42 can be suppressed more assuredly, and the deformation of the phase difference layer 42 can be suppressed further.

In addition, according to this embodiment, the side wall portion 42b having a variable thickness is included in the phase difference layer 42. However, a configuration in which the phase difference layer 42 is molded with high precision, and the side wall portion 42b having a variable thickness in a taper shape is not included may be used. In such a case, when the spacer 50 is disposed to be overlapped with the protection layer 44, which covers the side face of the phase difference layer 42, in the plan view, the layer thickness can be managed more assuredly.

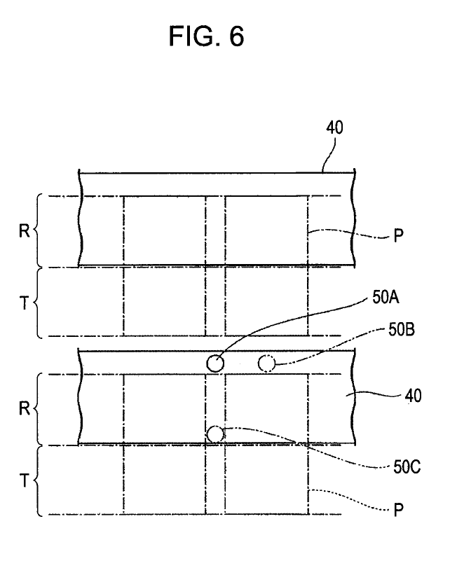

In addition, according to this embodiment, the spacer 50 is disposed in an area located between two adjacent sub pixels P. However, it is more preferable that the spacer 50 is disposed near the corner of two adjacent pixels. FIG. 6 is a plan view showing disposition of the spacer. In the figure, the spacer 50A is disposed in a position that is located near the corner of the sub pixel P and is not adjacent to the sub pixel P in the direction parallel or perpendicular to the extending direction of the inner side phase difference part 40. Such a position becomes an intersection between pixels that are formed in the matrix shape.

In order to dispose the spacer in positions denoted by reference symbols 50B and 50C, the spacer is disposed on the sub pixel P to be slightly deviated in the directions parallel and perpendicular to the extending direction of the inner side phase difference part 40. However, when a spacer 50A that is disposed near an intersection is slightly deviated in the horizontal direction or the vertical direction, the spacer is not disposed on the sub pixel P. Accordingly, a tolerance is allowed more or less. Therefore, disposition of the spacer can be performed in an easy manner, and thereby efficiency and simplification of the manufacturing process can be improved.

### Second Embodiment

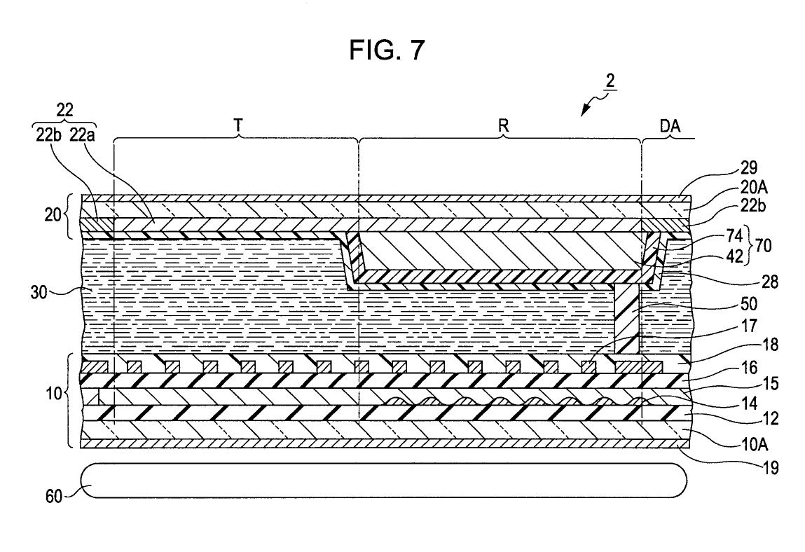

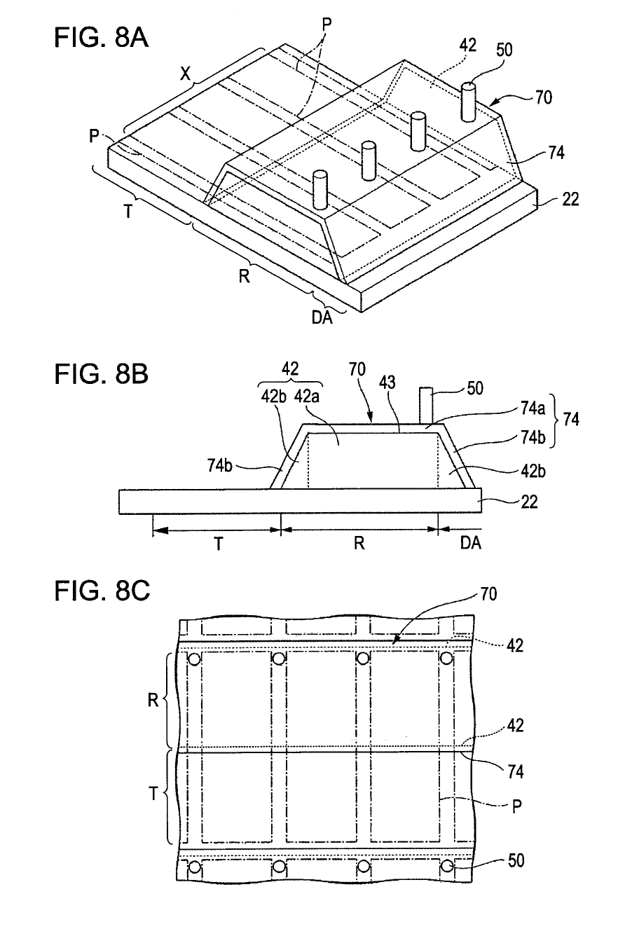

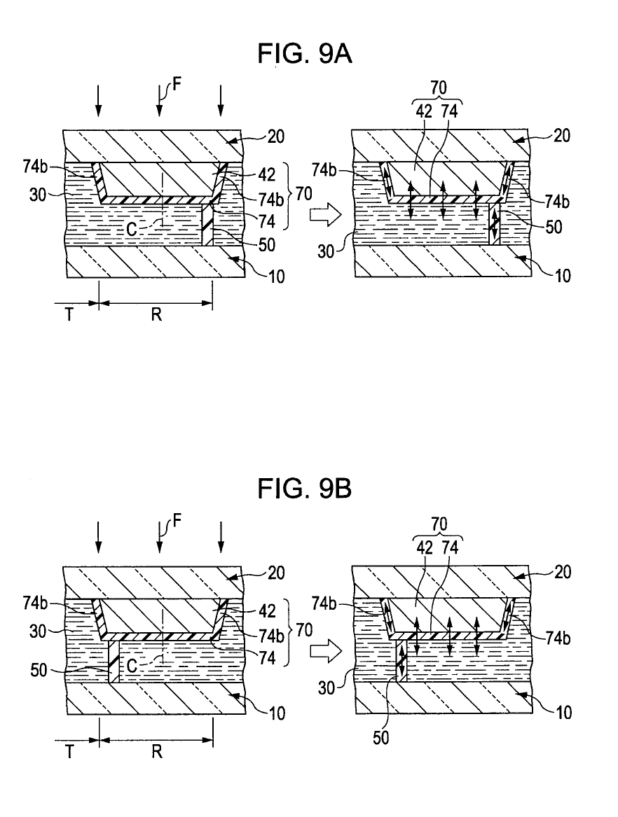

Hereinafter, a liquid crystal display device according to a second embodiment of the invention will be described with reference to FIG. 7, FIGS. 8A to 8C, and FIGS. 9A and 9B. In the liquid crystal display device according to the second embodiment, a protection layer covers a side face including a side face of a phase difference layer that is located on the boundary between a reflective display area and a transmissive display area so as to be brought into contact with a base face, which is different from the liquid crystal display device according to the first embodiment. However, the other configurations are the same as those of the first embodiment. To each constituent element common to the first embodiment, a same reference sign is assigned, and a duplicate description thereof is omitted here.

FIG. 7 is a cross-section view of a liquid crystal display device 2 according to the second embodiment. As shown in FIG. 7, the liquid crystal display device 2 includes a component substrate 10, an opposing substrate 20, a liquid crystal layer 30, an inner side phase difference part 70 that is formed to be overlapped with the reflective display area R on a face of the opposing substrate 20, which is located on the liquid crystal layer 30 side, in the plan view, and a spacer 50 that is disposed between the inner side phase difference part 70 and the component substrate 10.

The inner side phase difference part 70 is formed to include a phase difference layer 42 and a protection layer 74. The protection layer 74 is formed so as to cover the surface of the phase difference layer 42. The protection layer 74 covers an end portion of the phase difference layer 42 that is disposed in a non-display area DA and an end portion of the phase difference layer 42 that is disposed on the boundary between a reflective display area R and a transmissive display area T so as to be formed to be brought into contact with the surface of a color filter layer 22 that is a base face of the phase difference layer 42. The protection layer 74 is formed by using a formation material such as acrylic resin or epoxy resin that has hardness higher than that of the phase difference layer 42. As the formation material of the protection layer 74, an inorganic material such as silicon oxide (SiO₂) or silicon nitride (SiN) may be used.

FIGS. 8A, 8B, and 8C are schematic diagrams showing the periphery of the inner side phase difference part 70 and the spacer 50. FIG. 8A is a perspective view, FIG. 8B is a cross-section view, and FIG. 8C is a plan view. In FIGS. 8A to 8C, for easy understanding of the diagrams, the diagrams are shown to be vertically reversed, compared to FIG. 7.

As shown in FIG. 8A, the inner side phase difference part 70 extends in a band shape over an adjacent pixel X so as to be overlapped with the reflective display area R that is included in the sub pixel P. One end of the inner side phase difference part 70 in a direction perpendicular to the extending direction is located near the boundary between the transmissive display area T and the reflective display area R. In addition, the other end of the inner side phase difference part 70 is overlapped with the non-display area DA, which is an area between pixels, in the plan view.

The protection layer 74 that is included in the inner side phase difference part 70 extends in a band shape over an adjacent pixel X to be overlapped with the reflective display area R in the extending direction of the inner side phase difference part 70. The protection layer 74 covers a top portion of the phase difference layer 42, a side portion that is brought into contact with the non-display area DA, and a side portion that is brought into contact with the transmissive display area T so as to be formed to be brought into contact with the color filter layer 22 along the end portion of the phase difference layer 42 that is brought into contact with the color filter layer 22 in the non-display area DA and the transmissive display area T.

As shown in FIG. 8B, the protection layer 74 is configured by a first protection portion 74a that is formed so as to cover a flat portion 42a of the phase difference layer 42 and a second protection portion 74b that covers a side wall portion 42b of the non-display area DA side and a side wall portion 42b of the transmissive display area T side so as to be brought into contact with the color filter layer 22. As shown in FIG. 8C, an end portion of the protection layer 74 that is located on the transmissive display area T side is overlapped with the transmissive display area T in the plan view.

Subsequently, advantages of the second embodiment of the invention will be described with reference to FIGS. 9A and 9B. FIGS. 9A and 9B are explanatory diagrams showing the advantages of the second embodiment of the invention. FIGS. 9A and 9B are schematic cross-section views of the liquid crystal display device showing the periphery of the inner side phase difference part 70 and the spacer 50 and are cross-section views in the direction of a field of view corresponding to FIG. 7.

As shown in FIG. 9A, the protection layer 74 includes the second protection portion 74b that is brought into contact with the opposing substrate 20 also on the transmissive display area T side. Accordingly, when an external force F is applied from the outside of the liquid crystal display device, stress transferred to the phase difference layer 42 though the spacer 50 and the protection layer 74 is supported by the second protection portion 74b, which covers the side wall portion of the phase difference layer 42, on both sides like a partition. As a result, the deformation of the phase difference layer 42 can be suppressed more than in the first embodiment.

In addition, the second protection portion 74b supports the side wall portion of the phase difference layer 42 on both sides. Thus, for example, as shown in FIG. 9B, even when the spacer 50 is disposed on the transmissive display area T side, the deformation of the phase difference layer 42 can be suppressed at the same level as that for a case shown in FIG. 9A.

According to the liquid crystal display device 2 of the above-described configuration, the protection layer 74 covers the side wall portions 42b of all side faces of the phase difference layer 42 within one pixel so as to be disposed to be brought into contact with the color filter layer 22. Under such a configuration, the second protection portion 74b of the protection layer 74 is also brought into contact with the color filter layer 22 on the transmissive display area T side. Accordingly, the deformation of the phase difference layer 42 can be suppressed further, and restriction on the position in which the spacer 50 is disposed is alleviated.

In addition, the second protection portion 74b of the protection layer 74 that is brought into contact with the color filter layer 22 is also located in the transmissive display area T. However, a configuration in which a light shielding film is disposed in a position overlapped with a part in which the protection layer 74 is brought into contact with the color filter layer 22 in the plan view may be used. Under such a configuration, even when light leakage occurs in the part, in which the protection layer 74 is brought into contact with the color filter layer 22 in the transmissive display area T, the light can be shielded by using the light shielding film. Accordingly, the contrast of a displayed image can be improved, compared to a case where the light shielding film is not disposed.

### Third Embodiment

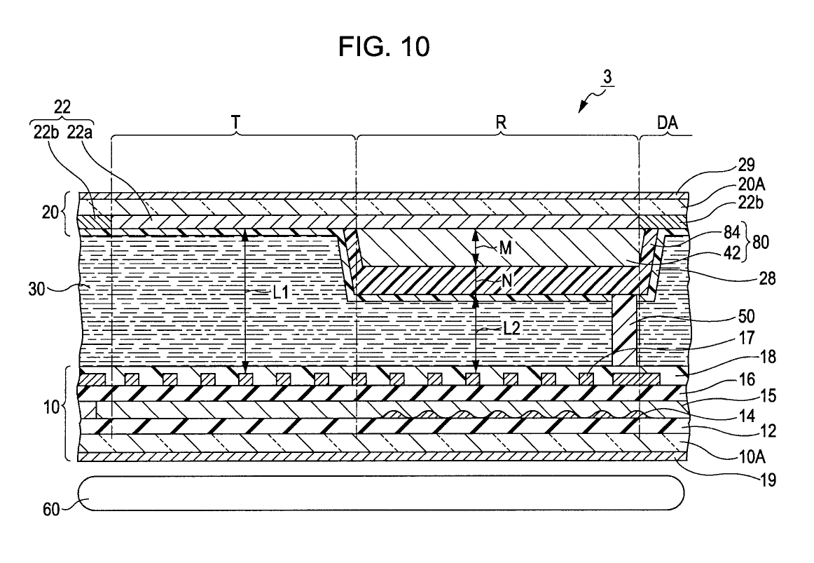

Hereinafter, a liquid crystal display device according to a third embodiment of the invention will be described with reference to FIG. 10. In the liquid crystal display device according to the third embodiment, a protection layer serves as a liquid crystal layer-thickness adjusting layer for adjusting the layer thickness of the liquid crystal layer in the transmissive display area and the reflective display area, which is different from the liquid crystal display device according to the second embodiment. However, the other configurations are the same as those of the second embodiment. To each constituent element common to the second embodiment, a same reference sign is assigned, and a duplicate description thereof is omitted here.

FIG. 10 is a cross-section view of a liquid crystal display device 3 according to the third embodiment. As shown in FIG. 10, the liquid crystal display device 3 includes a component substrate 10, an opposing substrate 20, a liquid crystal layer 30, an inner side phase difference part 80 that is formed to be overlapped with a reflective display area R on a face of the opposing substrate 20, which is located on the liquid crystal layer 30 side, in the plan view, and a spacer 50 that is disposed between the inner side phase difference part 80 and the component substrate 10.

The inner side phase difference part 80 is formed to include a phase difference layer 42 and a protection layer 84. The protection layer 84 is formed so as to cover the surface of the phase difference layer 42. The protection layer 84 covers an end portion of the phase difference layer 42 that is disposed in a non-display area DA and an end portion of the phase difference layer 42 that is disposed on the boundary between a reflective display area R and a transmissive display area T so as to be formed to be brought into contact with the surface of a color filter layer 22 that is a base face of the phase difference layer 42.

The protection layer 84 is formed by using a formation material such as acrylic resin or epoxy resin that has hardness higher than that of the phase difference layer 42. As the formation material of the protection layer 84, an inorganic material such as silicon oxide (SiO₂) or silicon nitride (SiN) may be used. In addition, the protection layer 84 may have a configuration in which a layer formed of acrylic resin or epoxy resin is laminated on a layer formed of an inorganic material such as silicon oxide (SiO₂) or silicon nitride (SiN).

The inner side phase difference part 80, as in the above-described embodiment, has a function for having the layer thickness L2 of the liquid crystal layer 30 in the reflective display area R to be thinner than the layer thickness L1 of the liquid crystal layer 30 in the transmissive display area T and adjusting the layer thickness L2 of the liquid crystal layer 30 in the reflective display area R and the layer thickness L1 of the liquid crystal layer 30 in the transmissive display area T to a predetermined thickness.

In the liquid crystal display device of a semi-transparent and a semi-reflective type, light incident to the reflective display area R is transmitted through the liquid crystal layer 30 twice. However, light incident to the transmissive display area T is transmitted through the liquid crystal layer 30 only once. Accordingly, in order to acquire image display with high brightness in both the reflective display area R and the transmissive display area T, it is required to prevent occurrence of a difference of optical transmittance by optimizing phase differences given to the light transmitted through the liquid crystal layer 30 in the reflective display area R and the transmissive display area T.

In order to optimize the phase differences given to the light transmitted through the liquid crystal layer 30 in the reflective display area R and the transmissive display area T, it is preferable that the layer thickness L2 of the liquid crystal layer 30 in the reflective display area R and the layer thickness L1 of the liquid crystal layer 30 in the transmissive display area T are configured to be predetermined thicknesses. For example, in a case where a phase difference given to the light transmitted through the liquid crystal layer 30 in the reflective display area R is a λ/4 wavelength and a phase difference given to the light transmitted through the liquid crystal layer 30 in the transmissive display area T is a λ/2 wavelength, the layer thickness L1 of the liquid crystal layer 30 in the transmissive display area T is set to about twice the layer thickness L2 of the liquid crystal layer 30 in the reflective display area R.

The layer thickness L2 of the liquid crystal layer 30 in the reflective display area R is controlled by the height of the spacer 50. On the other hand, the layer thickness L1 of the liquid crystal layer 30 in the transmissive display area T is controlled by the height (L2) of the spacer 50 and the thickness of the inner side phase difference part 80, that is, the thickness M of the phase difference layer 42 and the thickness N of the protection layer 84. Accordingly, in order to set the layer thickness L1 of the liquid crystal layer 30 in the transmissive display area T to a predetermined thickness, it is preferable that the thickness (M+N) of the inner side phase difference part 80 is formed with high precision.

Here, the phase difference layer 42 is formed to give a phase difference of a λ/2 wavelength to the light transmitted through the phase difference layer 42. By using the phase difference layer 42 and the liquid crystal layer 30 in the reflective display area R, the phase difference given to the light transmitted through the reflective display area R can be set to a λ/4 wavelength that is optimal for reflective display. However, since the thickness M of the phase difference layer 42 is dependent on the anisotropy of the refractive index of the formation material of the phase difference layer 42, it is difficult to form the thickness M of the phase difference layer 42 to any arbitrary thickness.

According to this embodiment, a configuration in which the protection layer 84 of the inner side phase difference part 80 achieves the function of substantially adjusting the layer thickness of the liquid crystal layer 30 is used. The protection layer 84 can be formed by adjusting the thickness N thereof in an easy manner, compared to the phase difference layer 42. Accordingly, by appropriately setting the thickness N of the protection layer 84 such that the thickness (M+N) of the inner side phase difference part 80 is a predetermined thickness, the layer thickness L2 of the liquid crystal layer 30 in the reflective display area R and the layer thickness L1 of the liquid crystal layer 30 in the transmissive display area T can be adjusted to predetermined thicknesses. For example, when the layer thickness L1 of the liquid crystal layer 30 in the transmissive display area T is set to be about twice the layer thickness L2 of the liquid crystal layer 30 in the reflective display area R, the thickness N of the protection layer 84 is set to a thickness corresponding to a difference between the height (L2) of the spacer 50 and the thickness M of the phase difference layer 42. Here, it is assumed that the thicknesses of the alignment film 18 and the alignment film 28 are ignored.

Under such a configuration, in the inner side phase difference part 80, the layer thickness L2 of the liquid crystal layer 30 in the reflective display area R and the layer thickness L1 of the liquid crystal layer 30 in the transmissive display area T are substantially adjusted by using the protection layer 84, and a phase difference given to the transmitted light is set by the phase difference layer 42. In other words, the thickness and the phase difference of the inner side phase different part 80 can be controlled independently. Accordingly, the layer thickness of the liquid crystal layer 30 can be managed precisely and easily, and the optical design of the phase difference layer 42 can be performed more precisely.

In addition, according to this embodiment, as in the second embodiment, the protection layer 84 covers a side face including a side face of the phase difference layer 42 that is located on the boundary between the reflective display area R and the transmissive display area T so as to be brought into contact with the surface of the color filter layer 22. However, as in the first embodiment, a configuration in which the protecting layer 84 covers a side face other than the side face, which is located on the boundary between the reflective display area R and the transmissive display area T, of the phase difference layer 42 so as to be brought into contact with the surface of the color filter layer 22 may be used. Under such a configuration, the same advantages as in this embodiment can be acquired.

### Modified Examples

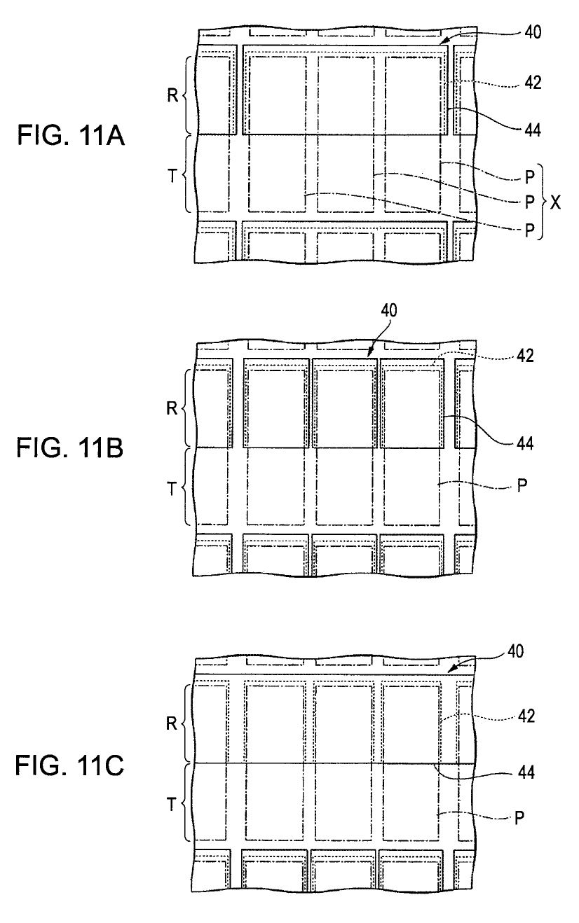

In the above-described embodiments, in the inner side phase difference parts 40, 70, and 80, the phase difference layer 42 formed in a band shape and the protection layer 44, 74, and 84 formed in a band shape are formed over the plurality of pixels. However, the inner side phase difference part is not limited thereto. FIGS. 11A, 11B, and 11C are schematic plan views showing modified examples of the inner side phase difference part 40 according to the first embodiment and are diagrams corresponding to FIG. 3C.

In the inner side phase difference part 40 shown in FIG. 11A, a phase difference layer 42 is disposed for each pixel X, and a protection layer 44 that surrounds the periphery of the phase difference layer 42 for each pixel so as to be brought into contact with a base face is included. In such a case, when an external force is applied, the number of the protection layers 44 that oppose stress for a case where an external force is applied is increased. Accordingly, deformation of the phase difference layer 42 is prevented, and thereby the layer thickness of the liquid crystal layer can be managed assuredly.

FIG. 11B shows a case where the configuration shown in FIG. 11A is divided further for each sub pixel P. Since the phase difference layer 42 is disposed for each sub pixel P, and the protection layer 44 that surrounds the periphery of the phase difference layer 42 so as to be brought into contact with a base face is included for each sub pixel. Under such a configuration, deformation of the phase difference layer 42 is prevented more strongly, and accordingly, the layer thickness of the liquid crystal layer can be managed assuredly.

In FIG. 11C, same as FIG. 11B, the phase difference layer 42 is disposed for each sub pixel P, and the protection layer 44 having a band shape which covers the plurality of the phase difference layers 42 is formed. Between adjacent phase difference layers 42, the protection layer 44 is formed to be brought into contact with the base face. Under such a configuration, the advantages of FIG. 11B can be acquired. In addition, a delicate patterning process for the protection layer 44 is not needed, and therefore a manufacturing process thereof can be performed easily.

Due to the configuration of the inner side phase difference part 40 as shown in FIGS. 11A to 11C and due to the shape of the inner side phase difference part 40, the number of spots at which there is a difference of the thickness of the inner side phase difference part 40 is increased. Accordingly, the number of flat spots that are appropriate for disposing the spacer 50 in the non-display area is decreased. In such a case, the spacer is disposed in an area in which an image is displayed, and light is shielded by using a light shielding film as needed. Accordingly, the effect on the image quality is decreased, and the layer thickness of the liquid crystal layer can be controlled assuredly.

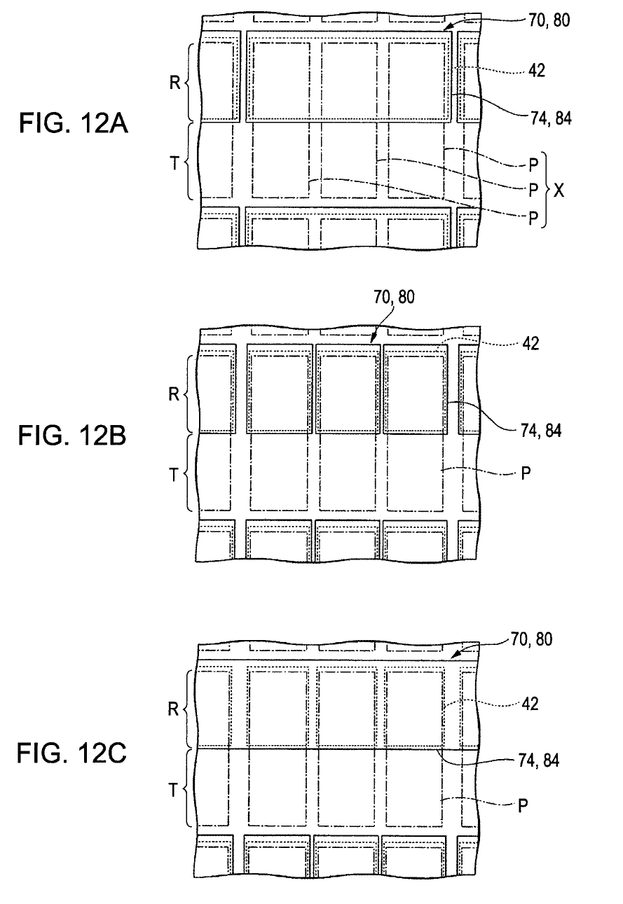

FIGS. 12A, 12B, and 12C are schematic plan views showing cases where the modified examples of the inner side phase difference parts 70 and 80 are applied to the second and third embodiments as described above and are diagrams corresponding to FIG. 8C. The configurations shown in FIGS. 12A, 12B, and 12C are in correspondence with the configurations shown in FIGS. 11A, 11B, and 11C. When the above-described modified examples are applied to the second and third embodiments, same advantages acquired from a case where the above-described modified examples are applied to the first embodiment can be acquired.

### Electronic Apparatus

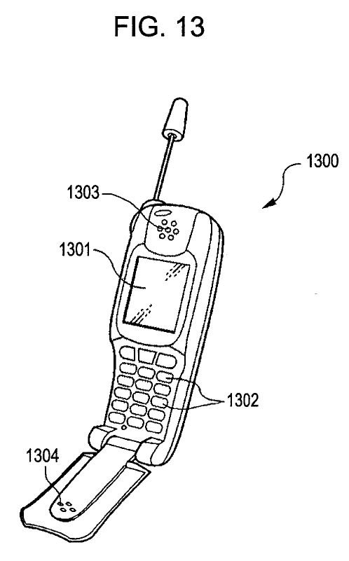

Next, an electronic apparatus according to an embodiment of the invention will be described. FIG. 13 is a perspective view showing an example of an electronic apparatus according to an embodiment of the invention. A cellular phone 1300 shown in FIG. 13 has the liquid crystal display device according to an embodiment of the invention as a small-sized display unit 1301 and is configured to include a plurality of operation buttons 1302, an earpiece 1303, and a mouthpiece 1304. Accordingly, the cellular phone 1300 having a display unit that is configured by the liquid crystal display device according to an embodiment of the invention and has superior display quality can be provided.

The application of the liquid crystal display device according to each of the above-described embodiments is not limited to the cellular phone. The liquid crystal display device may be used appropriately as an image display unit of an electronic book, a projector, a personal computer, a digital still camera, a television set, a video cassette recorder of a view finder type or a monitor direct-viewing type, a car navigation equipment, a pager, an electronic calendar, a calculator, a word processor, a workstation, a video phone, a POS terminal, an apparatus having a touch panel, or the like. Accordingly, by using the above-described configuration, an electronic device having a display unit that has high display quality and superior reliability can be provided.

As above, preferred embodiments of the invention have been described with reference to the accompanying drawings. However, it is apparent that the invention is not limited to the above-described embodiments. The shape and the combination of the constituent members described in the above-described embodiments are only examples and can be changed in various forms in accordance with a request for design or the like without departing from the gist of the invention.

The entire disclosure of Japanese Patent Application Nos: 2008-104373, filed Apr. 14, 2008 and 2009-008510, filed Jan. 19, 2009 are expressly incorporated by reference herein.

What is claimed is:

1. A liquid crystal display device comprising:
a first substrate and a second substrate that are disposed to face each other;
a liquid crystal layer that is sandwiched between the first substrate and the second substrate;
a phase difference layer disposed between the second substrate and the liquid crystal layer;
a protection layer that covers a face of the phase difference layer that faces the first substrate and a side face of the phase difference layer that is connected to the face of the phase difference layer, the protection layer contacting with a base face that becomes a base of the phase difference layer, the protection layer having a hardness higher than a hardness of the phase difference layer; and
a spacer that overlaps with the protection layer and that separates the first substrate and the second substrate apart by a predetermined gap.

2. The liquid crystal display device according to claim 1,
wherein a reflective display area and a transmissive display area are disposed within one pixel area,
wherein the phase difference layer is disposed in the reflective display area, and
wherein the protection layer covers a side face other than a side face of the phase difference layer that is located on a boundary between the reflective display area and the transmissive display area within one pixel area so as to be brought into contact with the base face.

3. The liquid crystal display device according to claim 2,
wherein a plurality of the pixel areas is arranged in one direction,
wherein, within the pixel areas, the reflective display area is disposed on one side and the transmissive display area is disposed on the other side with a center line that passes through a center of the pixel area and extends in parallel with the arrangement direction of the pixel areas interposed between the one side and the other side,
wherein the phase difference layer is formed in a band shape over a plurality of the reflective display areas that are aligned in the arrangement direction of the pixel areas,
wherein the protection layer covers a face of the phase difference layer formed in the band shape that faces the first substrate and a side face of the phase difference layer that is connected to the face of the phase difference layer and is located on a side opposite to the center line so as to be brought into contact with the base face, and
wherein the spacer is disposed on a boundary portion of an adjacent pixel area.

4. The liquid crystal display device according to claim 3, wherein the spacer is disposed on a side opposite to the transmissive display area relative to a center line that passes through the center of the reflective display area and extends in parallel with the arrangement direction of the pixel areas.

5. The liquid crystal display device according to claim 1,
wherein a reflective display area and a transmissive display area are disposed within one pixel area,
wherein the phase difference layer is disposed in the reflective display area, and
wherein the protection layer covers a side face including a side face of the phase difference layer that is located on a boundary between the reflective display area and the transmissive display area within one pixel area so as to be brought into contact with the base face.

6. The liquid crystal display device according to claim 1,
wherein the phase difference layer has a flat surface on a face that faces the first substrate, and
wherein the spacer is disposed to be overlapped with the flat surface.

7. The liquid crystal display device according to claim 1, wherein the protection layer serves as a liquid crystal layer-thickness adjusting layer for adjusting the layer thickness of the liquid crystal layer in the transmissive display area and the reflective display area.

8. The liquid crystal display device according to claim 1,
wherein the phase difference layer is formed by using a liquid crystal compound as a material, and
wherein the protection layer is formed by using an inorganic material as a material.

9. The liquid crystal display device according to claim 1, wherein the hardness of the protection layer is equal to or higher than the hardness of the spacer.

10. The liquid crystal display device according to claim 1, wherein the spacer is disposed integrally with the protection layer.

11. The liquid crystal display device according to claim 1, wherein the spacer is disposed integrally with the first substrate.

12. An electronic apparatus comprising the liquid crystal display device according to claim 1.
